(19) United States
(12) Patent Application Publication
(10) Pub. No.: US 2019/0153561 A1
(43) Pub. Date: May 23, 2019

(54) ENHANCED BINDERS FOR IRON ORE PELLETING AND CEMENT ADHESIVE MATERIALS

(71) Applicant: HPPE, LLC, Columbus, GA (US)

(72) Inventors: Ashoka V.R. Madduri, Columbus, GA (US); Charles R. Landis, The Woodlands, TX (US); Matthew B. Blackmon, Columbus, CA (US); Christopher P. Gardner, Columbus, GA (US); Sanket Gandhi, Columbus, GA (US)

(73) Assignee: HPPE, LLC, Columbus, GA (US)

(21) Appl. No.: 16/099,558

(22) PCT Filed: Jun. 20, 2017
(86) PCT No.: PCT/US2017/038329

§ 371 Date: Nov. 7, 2018

Related U.S. Application Data
(60) Provisional application No. 62/352,210, filed on Jun. 20, 2016.

(51) Int. Cl. C22B 1/244; C22B 1/248; C22B 1/24; C04B 18/02; C04B 28/04

(52) U.S. Cl. CPC C22B 1/244; C22B 1/248; C04B 24/38; C04B 18/022; C04B 28/04; C22B 1/2406

(57) ABSTRACT

The present invention is directed to composition and methods for iron ore pelleting and cement binders. More particularly, the binders are bio compatible crosslinked levan and crosslinked polysaccharides or groups or salts thereof.

### REFERENCE TO RELATED APPLICATIONS

This application claims priority to U.S. Provisional Application No. 62/352,210, filed Jun. 20, 2016, the entirety of which is hereby incorporated by reference.

### BACKGROUND

### 1. Field of the Invention

The invention is directed to compounds, compositions and methods comprising polysaccharide polymers such as Levan containing cross linking groups or salts thereof, thereby forming cross linked Levan. The invention is also directed to binding, strength, workability and water use industrial applications and methods for iron ore pelletizing and cement industries.

### 2. Description of the Background

The iron ore being mined globally can approximately be divided equally into boulders and fines. For further processing boulders have to be sized to 10-30 mm for blast furnaces and 6-18 mm for sponge iron plants. Iron ore in a finely ground state is not easily transported or readily processed. The iron ore pelletizing process agglomerates the fine ground ore into pellet using binders. The use of pellets increases the productivity in blast furnace and reduces coke consumption. These benefits along the iron ore processing chain push the global expansion of iron ore pelletizing (e.g., see U.S. Pat. No. 3,779,782 to D. V. Erickson; and WO 2009 109024 (PCT/BR2009/000057) to Bentonit União Nordeste Indústria E Comercio LTDA, which are incorporated by reference).

Two main systems, the Grate-Kiln System and the Straight-Grate system are common to produce the transportation friendly pellets. The process in both systems is similar and comprises three main steps: Raw material preparation, pellet formation and hardening of the pellets. The air temperature during the different thermal processing stages varies from 300° C. to 1300° C. (570 to 2,370° F.).

Burners are used to create the thermal energy required for the process. To make the process energy efficient the different amounts of combustion gases required for the different process steps need to be measured and controlled. Gas flow measurement in such an application represents a challenge due to the temperatures and the presence of particles. Proprietary air systems have been developed that use a correlation based technology such that the process cannot be plugged by dirt and is drift and generally maintenance free.

Metallic iron is produced by the direct reduction of iron ore in shaft-type reducing furnaces in which iron ore bodies are passed countercurrent to a reducing-gas stream. The iron ore bodies are generally pellets produced by pelletizing drums or rotating trays by agglomerating ground or milled iron or with moisture to produce “green” pellets or briquettes which are thereafter fired and burned to increase the rigidity of the pellets.

Green pellets thus produced are sent to a firing oven on conveyor belts and must have sufficiently high mechanical resistance to withstand shocks and falls that may occur during transport. Consequently, the pellets should arrive at the furnace with their physical integrity intact so as not to compromise the physical quality of the fired pellets. The types of problems that may occur with the green pellets during transport to the firing oven include: (i) deformation of the pellet due to compression squashing; (ii) deformation of the pellet due to impact squashing; (iii) breakage or chipping of the pellet by compression; and (iv) breakage or chipping of the pellet by impact.

Resistance of the green pellets to such problems depends on many factors that are directly related to iron ore and to materials called binders that are added to the aggregate. Conventional binders used in pelletizing iron ore comprises a silico-aluminous clay mineral bentonite and/or montmorillonite. Bentonite contains about 50% to 60% of silica and 13% to 17% of alumina depending on other characteristics of the clay. However, these highly sorbent hydrophilic synthetic mineral binders cause an increase in the content of silica and alumina which, as a consequence, produces a drop in total iron content of the pellet. As the material of economic interest of the pellet is iron, lowering the iron content reduces the overall value and also acceptability of the pellet on the market.

In addition, there are several aspects of this technique that are less than optimal for the production of iron ore. In many cases the resulting pellets have a tendency to dry prematurely, in other words prior to firing or in the course of firing, thereby losing a considerable amount of their tensile strength and giving rise to shattering or weakening of the pellets. Subsequent sintering does not appear to compensate for this loss of tensile strength. These binders introduce materials depleted in iron that further dilute the ore quality and produce waste during the firing process called “slag”. Furthermore, the problem increases in importance as additional proportions of water are used as is necessary with increasing fineness of the ore concentrate or ground iron ore.

Studies have been carried out over the years to develop so-called organic binders which are free of silica and which have the objective of totally substituting the bentonite in pelletizing processes. These organic binders are basically manufactured with industrial polymers originating from vegetable cellulose or polyacrylamide-based industrial polymers and have had limited success. The resulting pellets have a higher concentration of iron, but problems associated with deformation and breakage are exacerbated.

Attempts have also been made to use binders containing inorganic salts such as chlorides, iron sulfate, lime or calcium hydroxide in proportions of between 0.5 and 2% by weight. These binder compositions maintain, to a certain extent, the compressive strength and tensile strength of pellets, but only at temperatures between 100° C. and the sintering temperature.

Although binders containing high quality bentonite improves homogeneity of the metallurgical process when forming pellets, such binders are expensive and care must be taken to employ high-grade compounds. Accordingly, there is a need for an improved and cost effective biocompatible binder pelletizing iron ore.

### SUMMARY OF THE INVENTION

The present invention overcomes the problems and disadvantages associated with current strategies and designs and provide new tools, compositions and methods for the production of iron pellet and cement adhesives.

One embodiment of the invention is directed to binder compositions comprising: a cross-linked polysaccharide; and bentonite. Preferably the polysaccharide comprises levan, dextran, guar gum, scleroglucan, welan, xanthan gum, schizophyllan, cellulose and/or combinations thereof. Preferably the cross link of the cross-linked polysaccharide contains from 1 to 10 carbons. Preferably the cross linked polysaccharide comprises levan cross linked with epichlorohydrin. Preferably the polysaccharide contains moiety substitutions along from one or more of the saccharide unites of the polysaccharide. One or more substitutions may be present along one or more of the saccharide unites of the polysaccharide.

Another embodiment of the invention comprises methods of pelletizing a mineral ore comprising: providing mineral ore as boulders or fines, wherein boulders are reduced to approximately 5-30 mm in size; adding the binder composition of claim 1 to the mineral ore and forming agglomerates; and pelletizing the agglomerates forming mineral bore pellets. Preferably the mineral ore comprises iron ore that is manufactured to metallic iron. Preferably, the iron ore pellets have improved physical properties such as, for example, a dry compressive strength, a ball drop strength, pellet friability, and/or a tensile strength that is comparable to or greater than iron ore pellets manufactured with conventional binder compositions.

Another embodiment of the invention is directed to methods for manufacturing concrete or mortar comprising: providing a mix of cement, an amount of water and aggregate material; adding the binder of claim 1 to the mix to form a binder mix; and allowing the binder mix to harden over a period of time forming concrete or mortar. Preferably the cement is Portland cement, the aggregate material comprises sand or rock, and the period of time comprises a greater amount of time than would be necessary to form concrete or mortar without binder. Also preferably, the amount of water is from 5%-20% less than would be necessary to form concrete or mortar without binder as measured by ASTM certified slump test. Preferably the concrete or mortar has a decreased degree of structural deformation, an increased dry compression strength, and/or an increased tensile strength as compared to concrete or mortar manufactured without binder.

Another embodiment of the invention is directed to methods of making mineral ore and in particular iron-ore pellets, preferably for the direct reduction of iron ore to metallic iron. Preferably the binder composition contains crosslinked levan and/or levan polysaccharide derivatives.

Another embodiment of the invention is directed to methods of making improved bio compatible polymers of cement plasticizers. Polymers may comprise polysaccharides containing cross linking groups and/or their salts. Preferably the polysaccharide comprises levan, dextran, guar gum, scleroglucan, welan, xanthan gum, schizophyllan, levan or cellulose, and more preferably the polysaccharide is levan. Also preferably, the epichlorohydrin (EPCH) groups or their salts contain a carbon linker (C1-C8) and/or long chain hydroxy aliphatic groups or salts as side chains which may also contain a carbon linker (C1-C8).

Other embodiments and advantages of the invention are set forth in part in the description, which follows, and in part, may be obvious from this description, or may be learned from the practice of the invention.

### DESCRIPTION OF THE FIGURES

FIG. 1 Chemical process for the preparation of crosslinked Levan.

### DESCRIPTION OF THE INVENTION

Existing methods for the production of iron pellets and cement adhesives utilize binders that require high-grade compounds and are thus expensive and difficult to commercially produce. Bentonite is the traditional binder with different types of bentonite named after the respective dominant element, such as potassium (K), sodium (Na), calcium (Ca), and aluminum (Al). However, this bentonite, regardless of the dominant element, does not improve either the homogeneity of the metallurgical process or the quality of the resulting pellets, yet considerable increases cost.

It has been surprisingly discovered minerals, such as iron ore, can be pelletized by combining the mineral with a binder that comprises a crosslinked polysaccharide. Mineral ore is generally ground or a finely divided ore concentrate obtained by flotation or the like. Polysaccharides include, but are not limited to levan, dextran, guar gum, scleroglucan, welan, xanthan gum, schizophyllan, cellulose and/or combinations thereof. Linking compounds include linkers that create cross-linked polysaccharides with, preferably, from 1 to 10 carbons linkers. The polysaccharide may also include one or more substitutions of one or more saccharide units of the polysaccharide compound. Preferably the polysaccharide comprises levan and preferably the cross-linker comprises EPCH.

Binder composition of the invention are added to mineral ore during palletization as a main/primary binder or as a single component binder. The cross-linked polysaccharides to be employed in the present invention can vary broadly in type and is preferably sufficiently stable to be effective under the process conditions actually used such as, for example, high temperatures and strong caustic conditions (e.g., about 85° C.-107° C. {about 185° F.-225° F.}). This resulting mineral pellets increases the relative purity of ore pellets by decreasing the non-ore binder, improve the mixing and handling of the pellet which, in turn, lowers operational costs while uniformly reacting pellets of high structural strength and tensile strength.

One embodiment of the invention is directed to a binder composition containing a cross-linked polysaccharide and bentonite. Binder compositions of the invention are preferably aqueous and contain from 4-85% (by weight) cross-linked polysaccharide and a percentage (by weight) of bentonite. Preferably binder compositions of the invention contain from 10% to 50% less bentonite (by weight) than conventional binder compositions while maintaining or increasing dry compressive strength, ball drop strength, and improving pellet friability as compared to binder compositions without cross-linked polysaccharides of the invention. Conventional amounts of bentonite in binders are from 30-80% of the binder composition (by weight), whereas bentonite concentrations in binders of the invention contain from less than 30%, preferably less than 25%, preferably less than 20%, preferably less than 15%, preferably less than 10%, preferably less than 5%, and preferably less than 2% (by weight), Cross-linked polysaccharides of the invention, which may contain chemical moieties substitutions of one or more saccharides, preferably comprise from 10-80% (by weight) of the binder composition, preferably from 20-70%, preferably from 25-60%, preferably from 15-75%, preferably from 10-80%, preferably from 40-50%, and preferably from 25-50% (by weight)

Binder compositions of the invention may also contain molasses; polyacrylamide, starch, chlorides, iron sulfate, lime and/or calcium hydroxide. The composition may also comprise a synthetic polymer derived from natural polysaccharides such as carboxymethyl cellulose (CMC) or modified starches present in an amount of up to 10%, preferably from 4% to 8%, by weight based on the total weight of the binding mixture. Carbonates and bicarbonates of alkaline metals or soluble hydroxides from alkaline metals such as carbonates, bicarbonates or hydroxides of sodium, lithium or potassium may be present in a percentage of up to 20%, preferably from 7% to 20%, by weight of the binder composition. Preferably these additional components each comprise from 0.5 and 20% by weight of the composition. Preferably binder compositions of the invention do not increase or substantially increase the silica concentration of the pellet and/or do not reduce or substantially the mineral concentration of the mineral ore in the resulting pellet as compared to pellets made with conventional binder compositions.

Another embodiment of the invention is directed to the manufacture of concrete or mortar. Preferably, cement, water and an aggregate material are mixed with a binder composition of the invention and allowed to set over a period of time, optionally, in a form, to harden. Concrete or mortar manufactured using binder composition of the invention has increased tensile strength and increased dry compression strength as compared to concrete or mortar made without such binder. Also, water consumption is reduced during concrete production. Another advantage of this invention comprises providing bio compatible cement plasticizers for cement and concrete products. For example, the levan biopolymer is characterized by significantly higher reactivity and adhesion properties as compared to other known biopolymers such as guar and xanthan gums. Additionally, the intrinsic viscosity of levan in water is vanishingly low as compared to other polysaccharides.

An important additive in cement is called a plasticizer. Plasticizers are admixtures to a concrete or cement mix that improves the flow properties of a mix prior to hardening without negatively impacting the other properties after it sets. They are characterized by such properties as how much water is required or saved to maintain the flow properties, otherwise known as workability, the delay or acceleration of hardening (set time), and the impact it has on the final compressive strength of the cement with it in the mix. The most advanced category of plasticizers is called superplasticizers. These additives reduce water requirement by greater than or equal to 5% by weight of the cement, and are known as high range water reducer. These additives are used where well-dispersed cement particle suspension is required. These additives are used to minimized gravel, coarse and fine sands segregation, and enhance the flow properties workability. Superplasticizers to a concrete mix allow the water to cement ratio to be reduced. This increases the strength of the cement while maintaining the workability of the mixture. Strength of concrete increases as the water to cement ratio decreases.

Exemplary of the polymers which may be crosslinked for use in process of the present invention are acrylic, methacrylic, crotonic, etc., acid ester polymers such as polymers produced from the polymerization of methyl acrylate, ethyl acrylate, t-butyl acrylate, methyl methacrylate, ethyl methacrylate, cyclohexyl methacrylate, dimethyl aminoethyl methacrylate, dimethyl aminoethyl acrylate, methyl crotonate, etc., polymers of maleic anhydride and esters thereof, and the like; nitrile polymers such as those produced from acrylonitrile etc; amide polymers such as those produced from acrylamide, methacrylamide and the like.

Generally, these crosslinked polymers produced by reacting the containing the pendant reactive group, in solution, with a epichlorohydrin (EPCH) or its salt at a temperature ranging from about 50° C. to 100° C. for several hours. From about 1-90 percent of the available pendant reactive groups of the polymer may be replaced by epcichlorohydrin in accordance with said procedures.

The molecular weight of the polymers useful in the process of the present invention range from about 1 million to 50 million Daltons.

The polymers used in the present invention are employed by adding them, usually in the form of a dilute aqueous solution, to the iron ore and cement. Generally, for best results, at least about 0.5 gram, of the crosslinked Levan, per liter of the process stream should be employed. More preferably, at least one gram of the crosslinked Levan is added.

One or ordinary skill in the art will understand that higher amount may be employed without departing from the scope of the invention, although generally a point is reached in which additional amounts of crosslinked Levan do not improve the separation rate over already achieved maximum rates. Thus, it is uneconomical to use excessive amounts when this point is reached.

The following examples illustrate embodiments of the invention, but should not be viewed as limiting the scope of the invention.

### Examples

### Example 1 Preparation of Crosslinked Levan

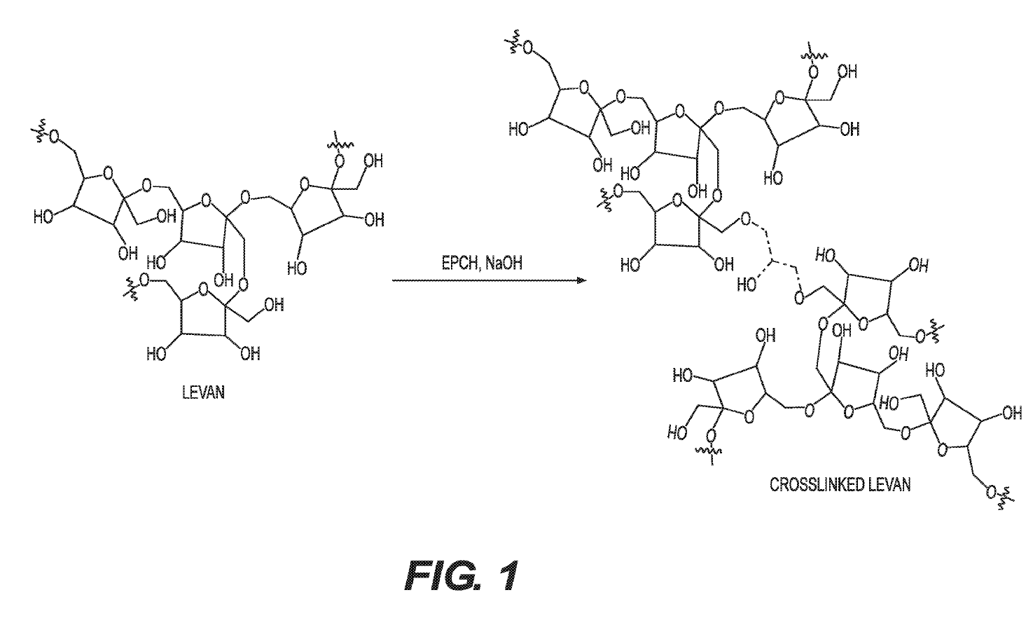

As shown in FIG. 1 and Tables 1 and 2, Levan polysaccharide was reacted with cross linker epichlorohydrin (EPCH) in water and base (NaOH) at elevated reaction temperatures to yield crosslinked Levan (TacBond, Spectre 82x, Spectre 825x and Spectre 8255x). Product produced comprises pellets containing cross-linked Levan of approximately 1-3 cms.

TABLE 1

| Mix | Slump (in.) | 3-day compressive Strength (psi) |
|---|---|---|
| Control | 2.5 | 4210 |
| Spectre 8255x | 6.25 | 4250 |

### Data:

### TacBond IOP Features

High water retention.
Much higher green tensile strength.
Much higher hydroxyl number (high adhesive strength).
Low viscosity (ease of handling).

TABLE 2

| Property | Spectre (82X) | Guar | Xanthan | CMC |
|---|---|---|---|---|
| Tensile Strength (psi) | 991 | 63 | 33 | 193 |
| Hydroxyl No. (mg KOH/g) | 89 | 27-29 | 20-30 | NA |
| Intrinsic Viscosity (dl/g) | 0.14 | 15 | 150 | 10-100 |
| Plate Water Absorption | 775 | 1030 | 4890 | 1270 |
| (PWA) | | | | |

*Bentonite: Biopolymer ratios: TacBond 90:10; Guar, Xanthan, CMC 50:50

Additional crosslinked polysaccharides may be utilized in accordance with the process of the disclosure herein.

### Example 2 Preparation of Ore Fines with Crosslinked Polysaccharides

Iron ore fines in the form of hardened pellets are formed from taconite ground very fine prior to beneficiation to increase the percentage content of iron oxide. Beneficiated iron ore fines are mixed with a binder composition and tumbled in a drum to produce pellets. The binder composition contains bentonite and a cross-linked polysaccharide. The presence of bentonite increases the structural strength of iron-ore pellets and aids in the formation of rounded structures. By adding Levan cross-linked with EPCH, the amount of bentonite of the binder composition is reduced.

Other embodiments and uses of the invention will be apparent to those skilled in the art from consideration of the specification and practice of the invention disclosed herein. All references cited herein, including all publications, and all U.S. and foreign patents and patent applications are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A binder composition comprising:
a cross-linked polysaccharide; and
bentonite.

2. The composition of claim 1, wherein the polysaccharide comprises.

3. The composition of claim 1, wherein the cross link of the cross-linked polysaccharide contains from 1 to 10 carbons.

4. The composition of claim 1, wherein the cross linked polysaccharide comprises levan cross linked with epichlorohydrin.

5. The composition of claim 1, wherein the polysaccharide contains substitutions along from one or more of the saccharide unites of the polysaccharide.

6. The composition of claim 1, wherein the polysaccharide contains substitutions along each of the saccharide unites of the polysaccharide.

7. A method of pelletizing a mineral ore comprising:
providing mineral ore as boulders or fines, wherein boulders are reduced to approximately 5-30 mm in size;
adding the binder composition of claim 1 to the mineral ore and forming agglomerates; and
pelletizing the agglomerates forming mineral bore pellets.

8. The method of claim 7, wherein the mineral ore comprises iron ore.

9. The method of claim 8, wherein the iron ore pellets have a dry compressive strength that is comparable to or greater than iron ore pellets manufactured with conventional binder compositions.

10. The method of claim 8, wherein the iron ore pellets have a ball drop strength that is comparable to or greater than iron ore pellets manufactured with conventional binder compositions.

11. The method of claim 8, wherein the iron ore pellets have a pellet friability that is comparable to or greater than iron ore pellets manufactured with conventional binder compositions.

12. The method of claim 8, wherein the iron ore pellets have a tensile strength that is comparable to or greater than iron ore pellets manufactured with conventional binder compositions.

13. A method for manufacturing concrete or mortar comprising:
providing a mix of cement, an amount of water and aggregate material;
adding the binder of claim 1 to the mix to form a binder mix;
allowing the binder mix to harden over a period of time forming concrete or mortar.

14. The method of claim 13, wherein the cement is Portland cement.

15. The method of claim 13, wherein the aggregate material comprises sand or rock.

16. The method of claim 13, wherein the period of time comprises a greater amount of time than would be necessary to form concrete or mortar without binder.

17. The method of claim 13, wherein the amount of water is from 5%-20% less than would be necessary to form concrete or mortar without binder as measured by ASTM certified slump test.

18. The method of claim 13, wherein the concrete or mortar has a decreased degree of structural deformation as compared to concrete or mortar manufactured without binder.

19. The method of claim 13, wherein the concrete or mortar has an increased dry compression strength as compared to concrete or mortar manufactured without binder.

20. The method of claim 13, wherein the concrete or mortar has an increased tensile strength as compared to concrete or mortar manufactured without binder.

21. A composition comprising a cross-linked polysaccharide, wherein the polysaccharide comprises levan, dextran, guar gum, and/or derivatives, salts and combinations thereof, and the polysaccharide comprises a carbon linker (C1-C8) and/or long chain hydroxy aliphatic groups or salts as side chains which may also contain a carbon linker (C1-C8).

22. The composition of claim 21, wherein the polysaccharide is cross-linked by epichlorohydrin (EPCH).
